(19) United States
(12) Patent Application Publication
(10) Pub. No.: US 2026/0106371 A1
(43) Pub. Date: Apr. 16, 2026

(54) ANTENNA ALIGNMENT DEVICE

(71) Applicant: Hubbell Incorporated, Shelton, CT (US)

(72) Inventors: Michael Robb Main, Aurora (CA); Mark Frischman, Thornhill (CA); Brian David Bourgoin, East Haddam, CT (US)

(73) Assignee: Hubbell Incorporated, Shelton, CT (US)

(21) Appl. No.: 19/357,752

(22) Filed: Oct. 14, 2025

Related U.S. Application Data
(60) Provisional application No. 63/707,098, filed on Oct. 14, 2024.

(51) Int. Cl. H01Q 3/04

(52) U.S. Cl. CPC H01Q 3/04

(57) ABSTRACT

A system for aligning an antenna includes an alignment tool and a bracket. The alignment tool has a first tool antenna and a second tool antenna. A first clamp portion is carried by one of the alignment tool and the bracket. A second clamp portion is carried by the other of the alignment tool and the bracket. The first clamp portion and the second clamp portion are operatively mateable and removable from one another to releasably secure the alignment tool to the bracket. The first clamp portion has at least two coupling regions that are spaced apart and simultaneously engageable with a respective at least two coupling regions of the second clamp portion.

### CROSS-REFERENCE TO RELATED APPLICATIONS

This application claims the benefit of U.S. Provisional Application No. 63/707,098, filed on Oct. 14, 2024, the entire disclosure of which is incorporated herein by reference.

### BACKGROUND OF THE DISCLOSURE

### 1. Field of the Disclosure

The present disclosure is directed to an antenna alignment system.

### 2. Description of Related Art

In the telecommunications industry, it is important to align antennas with precision to ensure optimal signal reception and transmission. Antenna alignment devices can be used for this purpose.

Antenna alignment devices are specialized devices designed to ensure the precise positioning of antennas for optimal signal transmission and reception. These devices typically incorporate components such as a Global Positioning System (GPS) module for accurate geographical coordinates, a compass (magnetometer) for measuring the azimuth angle relative to true north, and an inclinometer (tilt sensor) for assessing the antenna's vertical angle. Additional elements like gyroscopes enhance orientation stability, while user interfaces provide real-time data to technicians. Some tools also feature data storage and connectivity options for reporting and integration with network management systems.

However, antennas come in a wide variety of designs, sizes, and shapes, each tailored to specific applications and performance requirements. Because of this, universal-type brackets are often used so that antenna alignment devices can be mounted to many different antenna types. However, as should be appreciated by those skilled in the art, even such universal-type brackets will not be able to accommodate every antenna type.

It is often required that the bracket be attached to the antenna before installing the antenna alignment device onto the bracket. This is a typical install sequence because current bracket and antenna interfaces can be cumbersome to manipulate and require the use of tools. For example, existing designs use mounting screws and pins to attach the alignment device to the bracket accurately. Such installations can be difficult for technicians, especially when climbing a cell phone tower.

Once attached to the antenna using the mounting bracket, the antenna alignment device must be positioned and accurately referenced to a feature on the antenna, like a backplane plane, so that the antenna alignment device can report the accurate azimuth, tilt, and roll. After proper positioning on the antenna, the antenna alignment device measures the azimuth, tilt, and roll of the antenna using, for example, navigation satellite (e.g., GPS) technology and an accelerometer sensor.

U.S. Pat. No. 8,436,779, filed on Mar. 18, 2011, granted on May 7, 2013, relates to a system designed for aligning an antenna and keeping it in a specific reference position during the alignment process. The system includes a bracket that is attached to an antenna, with the bracket conforming to the shape of the antenna's back wall. The system is used to maintain the antenna's alignment relative to a predetermined point, line, or plane. The entire content of U.S. Pat. No. 8,436,779 is hereby incorporated by reference in its entirety.

U.S. Pat. No. 10,527,418, filed on Aug. 22, 2014, granted on Jan. 7, 2020, relates to a foldable, rotatable GPS compass system designed to ensure accurate antenna alignment, particularly in wireless communication systems. The device consists of two rotatable arms, each housing a GPS antenna, connected through a hollow hub. The system is designed to transition between compact and extended positions. The entire content of U.S. Pat. No. 10,527,418 is hereby incorporated by reference in its entirety.

Accordingly, it has been determined by the present disclosure that there is a continuing need for antenna alignment devices that overcome, alleviate, and/or mitigate one or more of the aforementioned and other deleterious effects of the prior art.

### SUMMARY OF THE DISCLOSURE

The disclosure provides a system for aligning an antenna includes an alignment tool and a bracket. The alignment tool has a first tool antenna and a second tool antenna. A first clamp portion is carried by one of the alignment tool and the bracket. A second clamp portion is carried by the other of the alignment tool and the bracket. The first clamp portion and the second clamp portion are operatively mateable and removable from one another to releasably secure the alignment tool to the bracket. The first clamp portion has at least two coupling regions that are spaced apart and simultaneously engageable with a respective at least two coupling regions of the second clamp portion. The at least two coupling regions can be three coupling regions, four coupling regions, or more. The at least two coupling regions can be spaced apart about a circumference.

In some embodiments according to the disclosure, either alone or together with any one or more of the aforementioned and/or after-mentioned embodiments, the system also includes an alignment tool with a proximal portion and a distal portion connected by a horizontally extending arm, with the first tool antenna in the proximal portion and the second tool antenna in the distal portion.

In some embodiments according to the disclosure, either alone or together with any one or more of the aforementioned and/or after-mentioned embodiments, the system also includes an alignment tool mountable to the bracket in a plurality of discrete orientations relative to the bracket.

In some embodiments according to the disclosure, either alone or together with any one or more of the aforementioned and/or after-mentioned embodiments, the system also includes an alignment tool mountable to the bracket in four orientations spaced 90 degrees apart.

In some embodiments according to the disclosure, either alone or together with any one or more of the aforementioned and/or after-mentioned embodiments, the system also includes a bracket with a strap and ratcheting levers configured to tighten the strap around an antenna to be aligned.

In some embodiments according to the disclosure, either alone or together with any one or more of the aforementioned and/or after-mentioned embodiments, the system also includes a bracket with an orienting bar that has a reference surface to register the bracket to an antenna to be aligned.

In some embodiments according to the disclosure, either alone or together with any one or more of the aforementioned and/or after-mentioned embodiments, the system also includes a bracket that carries identical instances of one of the first clamp portion and the second clamp portion on opposite sides of the bracket, with the alignment tool carrying the other clamp portion.

In some embodiments according to the disclosure, either alone or together with any one or more of the aforementioned and/or after-mentioned embodiments, the system also includes a bracket with a reference bar and a perpendicular reference surface configured to align with an azimuth indicator of a dish antenna to be aligned.

In some embodiments according to the disclosure, either alone or together with any one or more of the aforementioned and/or after-mentioned embodiments, the system also includes clamp portions that are rotatably lockable between a locked position that secures the alignment tool to the bracket and an unlocked position in which the clamp portions are separable.

In some embodiments according to the disclosure, either alone or together with any one or more of the aforementioned and/or after-mentioned embodiments, the system also includes a male wedge-cross feature on one clamp portion and a complementary female wedge-cross feature on the other, with rotation from the unlocked position to the locked position driving the features into a wedged interface.

In some embodiments according to the disclosure, either alone or together with any one or more of the aforementioned and/or after-mentioned embodiments, the system also includes an actuator lever operably coupled to one of the clamp portions and configured to rotate the clamp portions between the unlocked position and the locked position.

In some embodiments according to the disclosure, either alone or together with any one or more of the aforementioned and/or after-mentioned embodiments, the system also includes a ramp on one clamp portion that engages an undercut feature of the other to draw the clamp portions together during rotation into the locked position.

In some embodiments according to the disclosure, either alone or together with any one or more of the aforementioned and/or after-mentioned embodiments, the system also includes a ramp on one clamp portion that is retracted in the unlocked position and, during rotation into the locked position, advances to engage an undercut feature of the other to draw the clamp portions together.

In some embodiments according to the disclosure, either alone or together with any one or more of the aforementioned and/or after-mentioned embodiments, the system also includes a plurality of teeth on one clamp portion and a rotatable element with protrusions on the other that capture the teeth in the locked position.

In some embodiments according to the disclosure, either alone or together with any one or more of the aforementioned and/or after-mentioned embodiments, the system also includes cooperating tapered mating surfaces of the clamp portions that, upon rotation into the locked position, form a zero-clearance interface.

In some embodiments according to the disclosure, either alone or together with any one or more of the aforementioned and/or after-mentioned embodiments, the system also includes a cog on one clamp portion that is rotatable about a hub, with rotation of the cog from the unlocked position to the locked position positioning a protrusion to capture a tooth of the other clamp portion.

In some embodiments according to the disclosure, either alone or together with any one or more of the aforementioned and/or after-mentioned embodiments, the system also includes an actuator knob positioned under a plate of the bracket and configured to rotate a cog to move between the unlocked position and the locked position.

In some embodiments according to the disclosure, either alone or together with any one or more of the aforementioned and/or after-mentioned embodiments, the system also includes four actuator levers positioned at 90-degree intervals and linked so that toggling any lever rotates the cog.

In some embodiments according to the disclosure, either alone or together with any one or more of the aforementioned and/or after-mentioned embodiments, the system also includes a rotation from the unlocked position to the locked position of about 45 degrees.

In some embodiments according to the disclosure, either alone or together with any one or more of the aforementioned and/or after-mentioned embodiments, the system also includes a spring that maintains downward clamping pressure between the clamp portions in the locked position.

In some embodiments according to the disclosure, either alone or together with any one or more of the aforementioned and/or after-mentioned embodiments, the system also includes a plate on the bracket with a machined cutout sized to receive components of the clamp portion.

In some embodiments according to the disclosure, either alone or together with any one or more of the aforementioned and/or after-mentioned embodiments, the system also includes a reversal of the male and female wedge-cross orientation such that the male wedge-cross feature is on the alignment tool and the female wedge-cross feature is on the bracket.

In some embodiments according to the disclosure, either alone or together with any one or more of the aforementioned and/or after-mentioned embodiments, the system also includes sloped mating surfaces and corner radii that facilitate debris shedding while maintaining alignment accuracy.

In some embodiments according to the disclosure, either alone or together with any one or more of the aforementioned and/or after-mentioned embodiments, the system also includes software associated with the alignment tool that compensates for a selected tool orientation to report actual antenna alignment.

In some embodiments according to the disclosure, either alone or together with any one or more of the aforementioned and/or after-mentioned embodiments, the system also includes measurement of azimuth, tilt, and roll using navigation satellite technology and an accelerometer sensor.

In some embodiments according to the disclosure, either alone or together with any one or more of the aforementioned and/or after-mentioned embodiments, the system also includes use with dish antennas having azimuth indicators such as drainage holes or an indentation that define the azimuth reference.

The disclosure provides a method that includes mating a first clamp portion carried by one of an alignment tool and a bracket with a second clamp portion carried by the other by rotating the clamp portions from an unlocked position to a locked position to secure the alignment tool to the bracket.

In some embodiments according to the disclosure, either alone or together with any one or more of the aforementioned and/or after-mentioned embodiments, the method also includes moving the clamp portions to the unlocked position to release the alignment tool.

In some embodiments according to the disclosure, either alone or together with any one or more of the aforementioned and/or after-mentioned embodiments, the method also includes aligning a reference bar of the bracket with an azimuth indicator of an antenna to be aligned and abutting a reference surface of the bracket against a surface of the antenna to be aligned.

In some embodiments according to the disclosure, either alone or together with any one or more of the aforementioned and/or after-mentioned embodiments, the method also includes selecting one of four orientations of the alignment tool relative to the bracket that are spaced 90 degrees apart and compensating in software for the selected orientation when reporting antenna alignment.

In some embodiments according to the disclosure, either alone or together with any one or more of the aforementioned and/or after-mentioned embodiments, the method also includes tightening a strap of the bracket around the antenna using ratcheting levers before measuring alignment parameters.

In some embodiments according to the disclosure, either alone or together with any one or more of the aforementioned and/or after-mentioned embodiments, the method also includes aligning a reference surface of the bracket against a rear or front surface of the antenna while aligning a reference bar with the azimuth indicator.

The disclosure provides an antenna alignment tool that includes a first tool antenna, a second tool antenna, and a first clamp portion carried by the tool, the first clamp portion being configured to operatively mate with and be removable from a complementary second clamp portion on a bracket to releasably secure the tool to the bracket.

In some embodiments according to the disclosure, either alone or together with any one or more of the aforementioned and/or after-mentioned embodiments, the tool also includes the first clamp portion on a bottom side of the proximal portion.

In some embodiments according to the disclosure, either alone or together with any one or more of the aforementioned and/or after-mentioned embodiments, the tool also includes a recess formed by perpendicular grooves and a circular recess at their intersection, with teeth arranged about the circular recess at 90-degree intervals.

In some embodiments according to the disclosure, either alone or together with any one or more of the aforementioned and/or after-mentioned embodiments, the tool also includes a horizontally extending arm that connects the proximal portion and the distal portion to establish a fixed baseline between the first tool antenna and the second tool antenna.

In some embodiments according to the disclosure, either alone or together with any one or more of the aforementioned and/or after-mentioned embodiments, the bracket also includes a cross-shaped housing with limbs spaced 90 degrees apart and notches adjacent the limbs to receive portions of the tool clamp.

In some embodiments according to the disclosure, either alone or together with any one or more of the aforementioned and/or after-mentioned embodiments, the bracket also includes an L-bracket that carries a reference surface perpendicular to a reference bar and connects to a plate on the bracket.

In some embodiments according to the disclosure, either alone or together with any one or more of the aforementioned and/or after-mentioned embodiments, the bracket also includes a tensioner with ratcheting levers configured to tighten a strap around the antenna.

In some embodiments according to the disclosure, either alone or together with any one or more of the aforementioned and/or after-mentioned embodiments, the bracket also includes a tapered surface that cooperates with a ramped element to create a zero-clearance interface in the locked position with an air gap at a horizontal surface.

In some embodiments according to the disclosure, either alone or together with any one or more of the aforementioned and/or after-mentioned embodiments, the bracket also includes identical second clamp portions on top and bottom sides to receive the alignment tool from either side.

### BRIEF DESCRIPTION OF THE DRAWINGS

The accompanying drawings illustrate aspects of the present disclosure and, together with the general description given above and the detailed description given below, explain the principles of the present disclosure. As shown throughout the drawings, like reference numerals designate like or corresponding parts.

FIG. 1 shows a perspective view of an antenna alignment system according to the present disclosure.

FIG. 2 shows the antenna alignment system of FIG. 1 with an alignment tool oriented in an alternate position.

FIG. 3 shows the antenna alignment system of FIG. 1 with an alignment tool oriented in another alternate position.

FIG. 4 shows a close-up of attachment interface 112.

FIG. 5 shows a perspective view of an alignment tool.

FIG. 6 shows a bottom view of the alignment tool of FIG. 5.

FIG. 7 shows a side view of the alignment tool of FIG. 5.

FIG. 8 shows a perspective view of a mating portion of the alignment tool of FIG. 5.

FIG. 9 shows a bottom view of the mating portion of the alignment tool of FIG. 8.

FIGS. 10A to 10F show various views of a tooth of the mating portion of FIG. 8.

FIG. 11 shows a perspective view of a bracket.

FIG. 12 shows a side view of the bracket of FIG. 11.

FIG. 13 shows a top view of the bracket of FIG. 11.

FIG. 14 shows a bottom view of the bracket of FIG. 11.

FIG. 15 shows a perspective view of a tensioner of the bracket of FIG. 11.

FIG. 16 shows a perspective view of a mating portion of the bracket of FIG. 10.

FIG. 17 shows certain isolated components from the mating portion of FIG. 15.

FIG. 18 shows an exploded view of the components of FIG. 15.

FIG. 19 shows a bottom view of the mating portion of the bracket of FIG. 11.

FIGS. 20A and 20B show unlocked and locked positions, respectively, of the mating portions of the bracket and alignment.

FIGS. 21A and 20B show unlocked and locked positions, respectively, of the mating portions of the bracket.

FIG. 22 shows a perspective view of another antenna alignment system according to the present disclosure.

FIG. 23 shows a bottom perspective view of the antenna alignment system of FIG. 22.

FIG. 24 shows a front view of the antenna alignment system of FIG. 22.

FIGS. 25 to 27 shows example antennas for which the antenna alignment system of FIG. 22 can be used.

FIGS. 28 to 30 show the system of FIG. 22 in use with the antenna of FIGS. 25 to 27, respectively.

### DETAILED DESCRIPTION OF THE DISCLOSURE

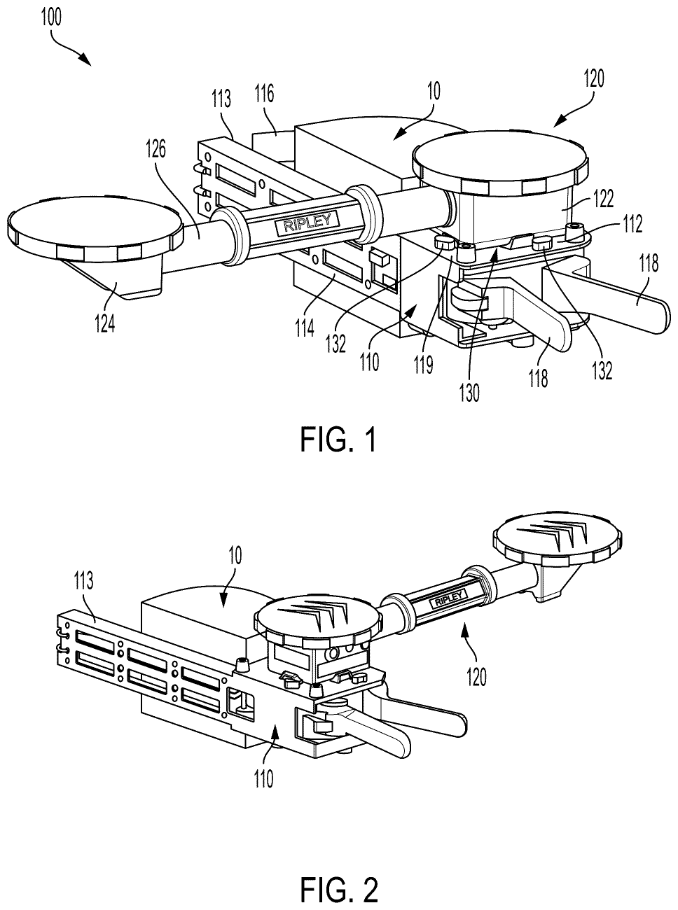

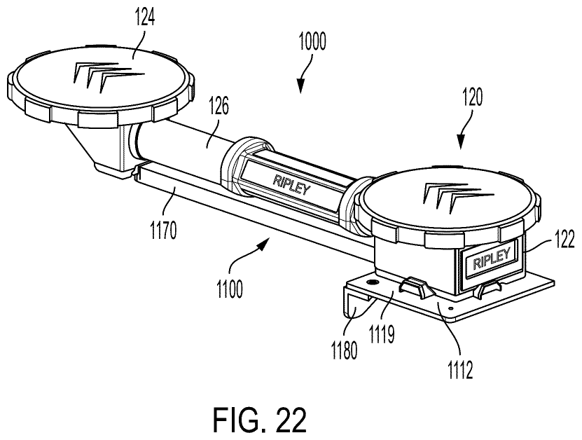

Referring to the drawings, and in particular to FIGS. 1 and 22, exemplary embodiments of antenna alignment systems 100, 1100 according to the present disclosure are shown.

Advantageously, system 100, 1100 provides a quick and repeatable connection between an alignment tool 120 and a bracket 110 or a bracket 1100. When used with bracket 110, the bracket can be secured to a support, i.e., an antenna backplane, to align tool 120 to the antenna on that support. When used with bracket 1100, the bracket can be placed on the antenna, aligned with azimuth alignment indicators on the antenna.

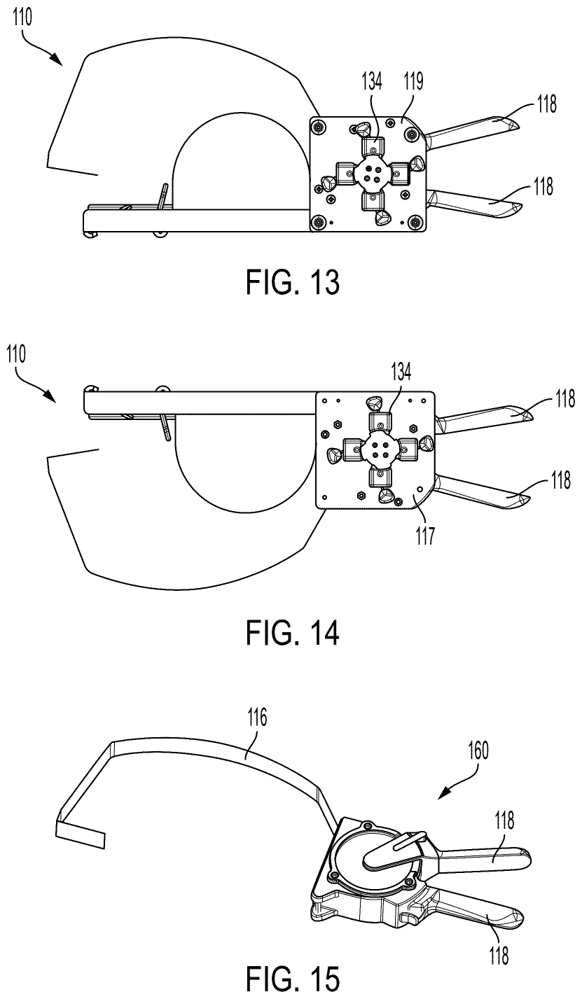

Antenna alignment system 100 is described with simultaneous reference to FIGS. 1 to 22. System 100 includes a bracket 110 and an alignment tool 120 that can be secured together by a clamp 130. Bracket 110 provides an interface between alignment tool 120 and antenna 10.

Advantageously, the present disclosure provides an antenna alignment system 100 with a bracket 110 that is easy to install on an antenna 10 and an alignment tool 120 that is easy to install on the bracket without requiring the use of fasteners, i.e., screws, bolts, or tools, so that the antenna alignment system can establish a very accurate and precise mounting interface with the antenna.

Clamp 130 is a quick-release clamp, preferably a lever-activated rotary lock system that rotates between a locked and unlocked position by toggling a lever 132. In the locked position, alignment tool 120 and bracket 110 are securely connected. In the unlocked position, alignment tool 120 and bracket 110 are disconnected. Accordingly, clamp 130 enables a quick and easy toggle between a locked position to install alignment tool 120 on bracket 110 and an unlocked position to remove the alignment tool from the bracket. An end user, with or without gloves, can simply toggle lever 132 between a locked and unlocked position to operate clamp 130 to quickly and accurately establish a secure connection between the alignment tool and bracket at an attachment interface 112.

Bracket 110 includes an orienting bar 114 to orient the bracket relative to antenna 10, a strap 116 that can be tightened around the antenna, and a pair of ratcheting levers 118, operable to tighten the strap. Bracket 110 also has a plate 119 that provides a horizontal surface on which a bracket portion of clamp 130 is located.

Orienting bar 114 includes a reference surface 113.

Alignment tool 120 includes a proximal portion 122 that mounts to bracket 110 and a distal portion 124 connected by a horizontally extending arm 126. A tool portion of clamp 130 is located on the bottom side of proximal portion 122.

The tool portion of clamp 130 is a first mating half 136, and the bracket portion of clamp 130 is a second mating half 134 of two mating halves that clamp together at attachment interface 112. The location of each mating half can be swapped. That is, although the features of first mating half 136 are shown and described as being located on alignment tool 120, these features can alternatively be located on bracket 110. Likewise, the features of second mating half 134 that are shown and described as being located on bracket 110 can alternatively be located on bracket 110.

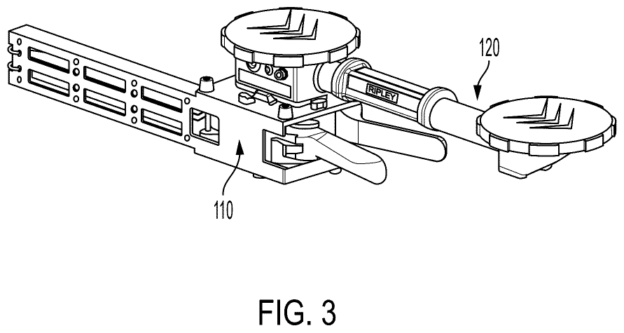

Alignment tool 120 can be mounted on bracket 110 at any one of four 90-degree spaced apart orientations that are parallel or perpendicular to reference surface 113. A first orientation is shown in FIG. 1, a second orientation is shown in FIG. 2, where alignment tool 120 has an orientation rotated 180 degrees relative to the orientation in FIG. 1, and a third orientation is shown in FIG. 3, where alignment tool 120 has an orientation rotated 90 degrees relative to the orientation in FIG. 1. In a fourth orientation, not shown, alignment tool 120 has an orientation rotated 180 degrees relative to the orientation in FIG. 3.

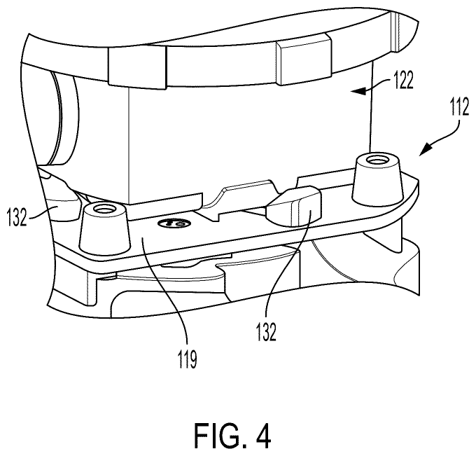

FIG. 4 shows a close-up of attachment interface 112. Proximal portion 122 is mounted to plate 119 with clamp 130. Lever 132 is toggled to the locked position so that bracket 110 and alignment tool 120 are securely mounted together.

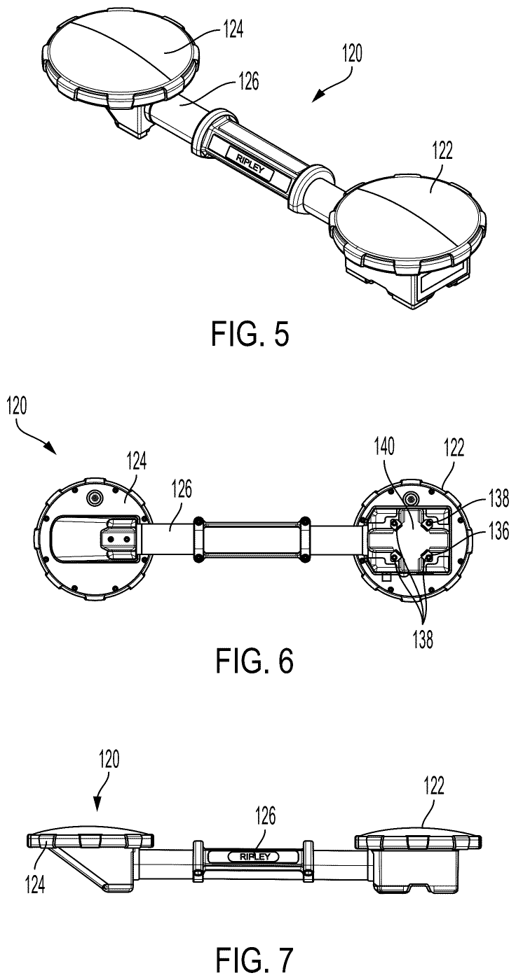

FIGS. 5, 6, and 7 show perspective, bottom, and side views of alignment tool 120. Distal portion 124 includes a first antenna. Proximal portion 122 includes a second antenna. A horizontally extending arm 126 connects proximal portion 122 and distal portion 124. As can be seen in FIG. 6, first mating half 136 of clamp 130 is located on a bottom side of proximal portion 122.

First mating half 136 of clamp 130 includes a recess 140 and a plurality of teeth 138. Recess 140 is defined by a pair of perpendicularly oriented grooves forming a cross or plus-shaped recess and a circular recess at an intersection of the grooves.

Teeth 138 are spaced apart about a circumference of the circular recess at 90-degree intervals, 45 degrees relative to the grooves.

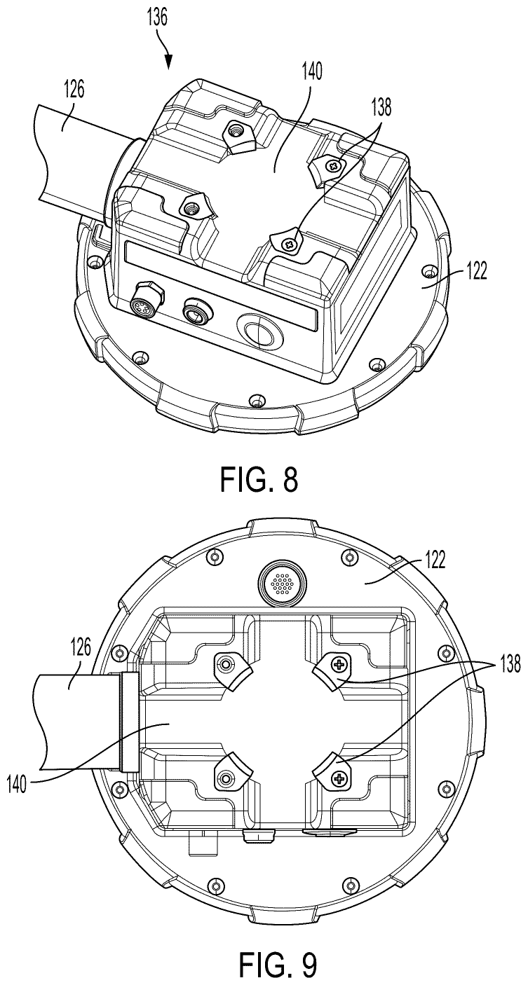

FIGS. 8 and 9 show perspective and bottom views, respectively, of proximal portion 122, and particularly first mating half 136.

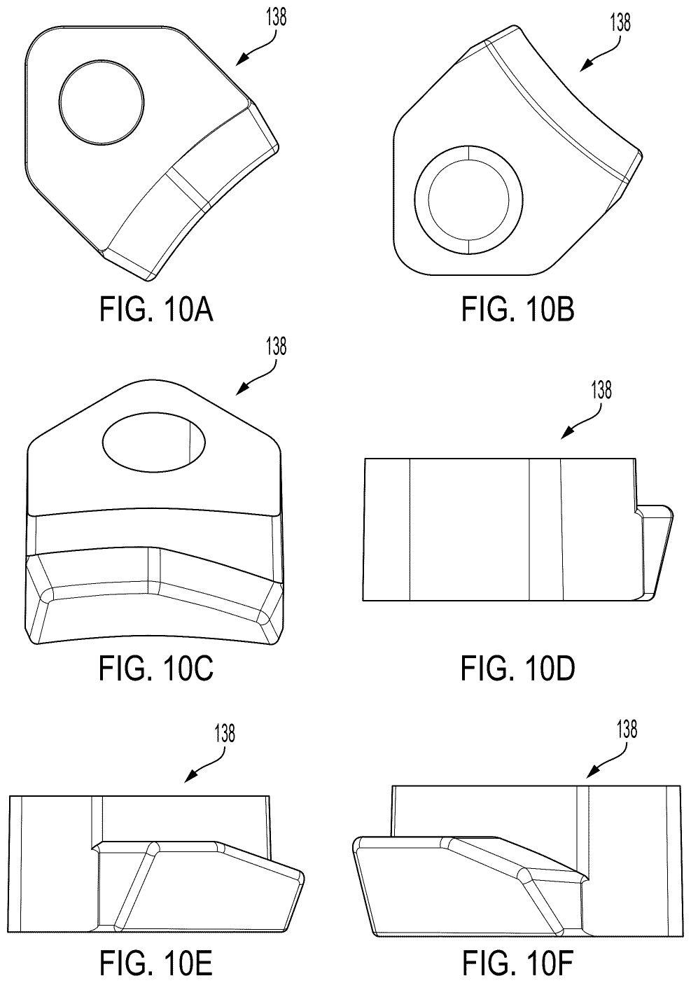

FIGS. 10A to 10F show various views of a tooth 138.

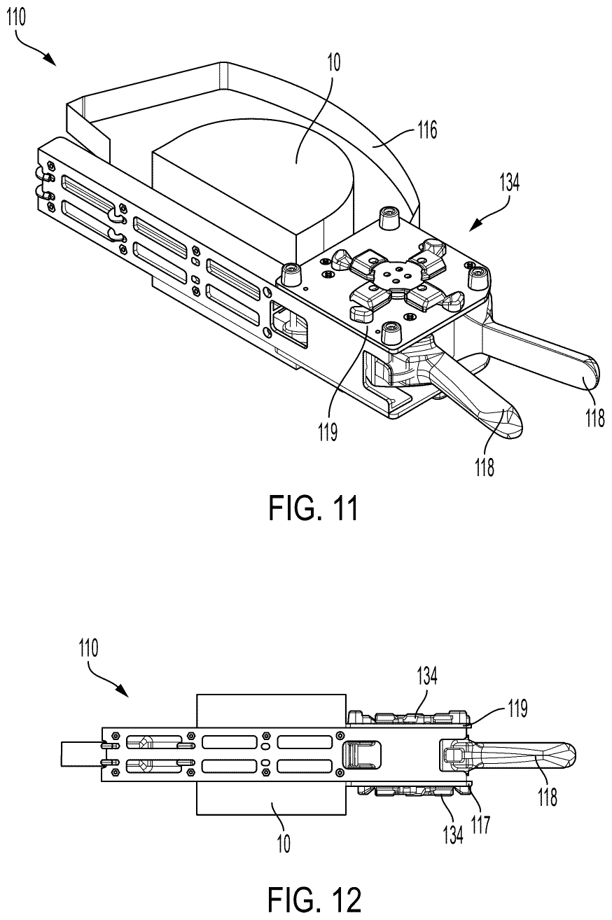

FIGS. 11, 12, 13, and 14 show perspective, side, top, and bottom views of bracket 110. Second mating half 134 is mounted on plate 119 on top of bracket 110. An identical second mating half 134 is also mounted on a plate 117 on a bottom side of bracket 110. Shown here as mounted on both sides, second mating half 134 can be mounted on either or both sides.

FIG. 15 shows a tensioner 160 that is part of bracket 110. Tensioner 160 includes ratcheting levers 118 that tighten strap 116.

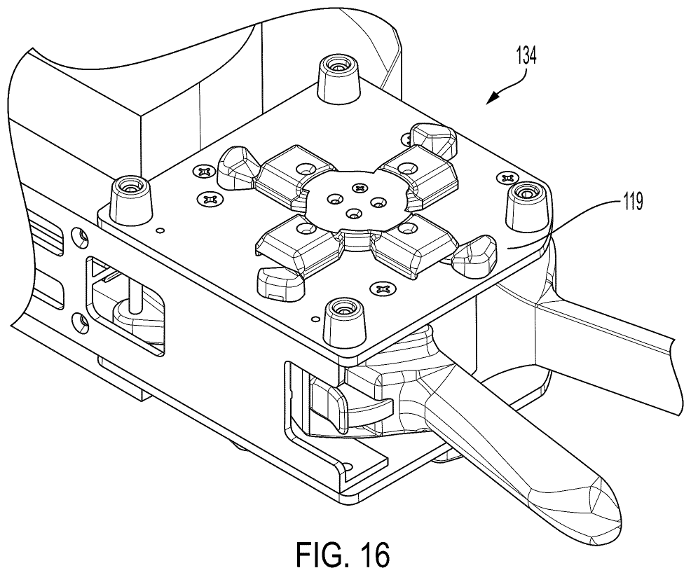

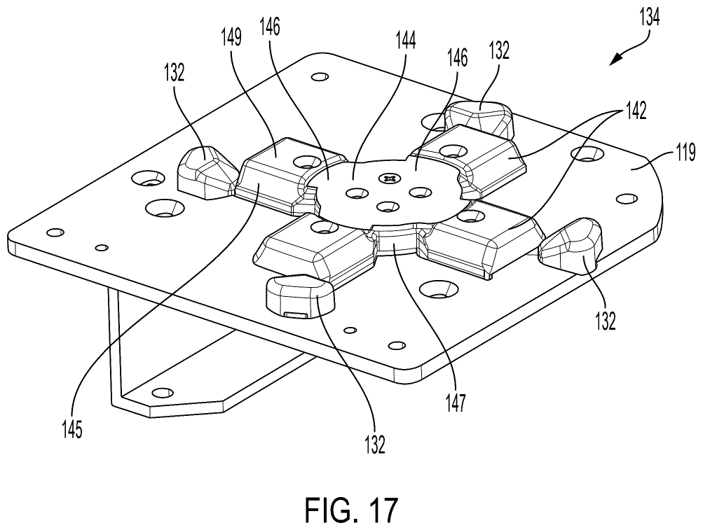

FIGS. 16 and 17 show perspective detail views of second mating half 134.

In FIG. 17, some of the components have been isolated.

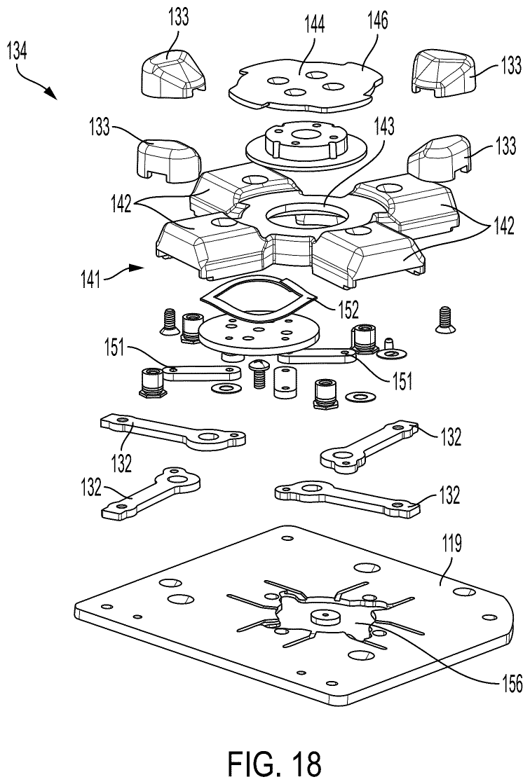

FIG. 18 shows an exploded view of the components of second mating half 134. The second mating half 134 has a housing 141 with four limbs 142 extending away from a central hub 143 to define a cross shape. Each limb 142 is disposed 90 degrees apart. Adjacent to each limb 142 is a notch 147. There are four notches 147, each spaced apart by 90 degrees. This structure is sized and shaped so that housing 141 can be received by recess 140 in any of four different orientations 90 degrees apart, while teeth 138 are received in a respective notch 147.

A cog 144 is rotatable about hub 143 and operable by lever 132. There are four levers 132 located 90 degrees apart. Any one of them can be toggled by a user. They are all connected, and a user can toggle any one of them. When one of the levers is toggled, the other three levers are also toggled. Toggling lever 132 causes cog 144 to rotate.

Cog 144 has four protrusions 146 located 90 degrees apart. In the unlocked position, protrusions 146 are aligned with limbs 142. When lever 132 is toggled, cog 144 rotates 45 degrees to cause protrusions to rotate over notches 147. When first mating half 136 is positioned in second mating half 134, protrusions 146 engage teeth 138 to retain bracket 110 and alignment tool 120 securely connected.

A spring 152 facilitates maintaining a tension between bracket 110 and alignment tool 120 to hold them in place.

Lever 132 has finger-engagable knobs 133. Levers 132 are connected to hub 143 by respective arms 151.

Plate 119 has a machined cutout 156 for receiving the components.

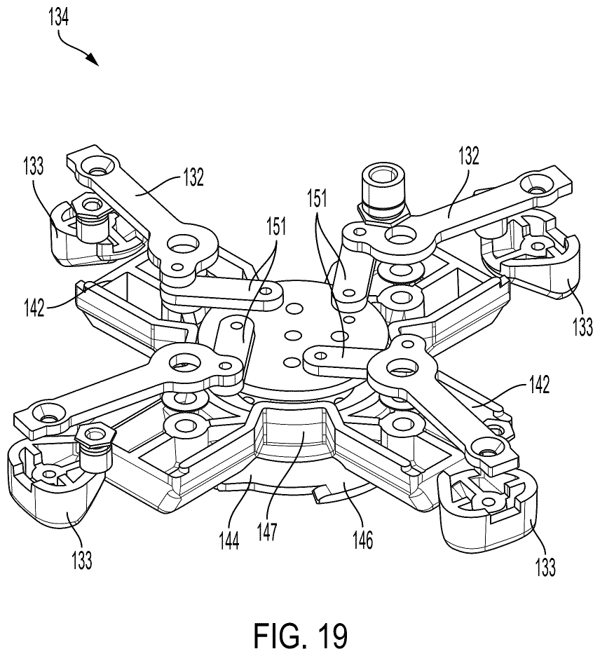

FIG. 19 shows a bottom view of second mating half 134.

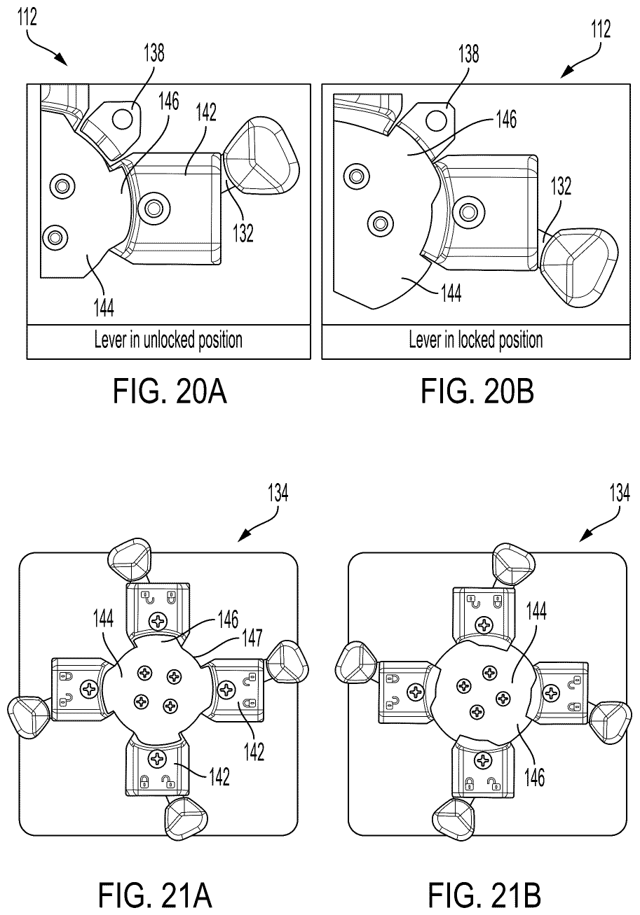

FIGS. 20A and 21A show the unlocked position of attachment interface 112. FIGS. 20B and 21 B show the locked position. FIGS. 20A and 20B show teeth 138 in conjunction with second mating half 134. As shown, in both positions, tooth 138 is positioned in notch 147. In the locked position, protrusion 146 is rotated 45 degrees relative to the unlocked position and positioned over tooth 138.

FIGS. 21A and 21B only show second mating half 134 without the teeth 138 of first mating half 136.

Advantageously, first and second mating halves 136 and 134 have connecting wedge cross features that create a tapered edge action between alignment tool 120 and bracket 110. Alignment tool 120 has integrated features to establish a mounting orientation in 90-degree intervals. Bracket 110 has a mating feature to receive the integrated feature so that there is always a 90-degree relative orientation between the alignment tool 120 and bracket 110. This is also advantageous because secondary planar considerations in the roll and tilt orientation are also accurately maintained by this system 100. As alignment tool 120 is placed on the wedge cross of second mating half 134, the female feature in alignment tool 120 can be tightly and securely coupled to retain very accurate 90-degree “clocking”to the male feature in the bracket.

Limb 142 includes a tapered surface 145 having a ramp and a horizontal surface 149 having a mating surface of alignment tool 120. When a ramp of cog 144 pulls down, tapered surface 145 acts as a point of contact and creates a “zero clearance interface”. When cog 144 is rotated to the lock position, there is an air gap at horizontal surface 149. Spring 152, located under the cog, allows it to maintain the downward pressure.

As previously mentioned, the male/female orientation of the wedge cross can be reversed in other designs.

A four-sided wedge cross enables the end user to mount the tool at any 90-degree interval, achieving the same precise result. Since tools in the field are subject to dirt & debris. The sloped walls and corner radii of both male & female wedge-cross features support easy cleaning of the sloped mating surfaces to maintain accuracy of alignment.

Bracket 110 and its lever-activated rotary lock system employ a flexible ramp to provide downward force when the lever is in the locked position. The ramp rotates with the lever system and engages an undercut feature on alignment tool 110, i.e., tooth 138. The ramp engages alignment tool 120 and creates a downward clamping action, driving the male and female wedge cross features together. The downward force creates a zero clearance fit between the male and female wedge cross features. When lever 132 is in the unlocked position, the ramps are retracted to a stowed position and do not create interference with alignment tool 110's teeth 138, so the alignment tool can easily be lifted off bracket 110.

Since the alignment tool 120 has an integrated female wedge cross feature, modular bracket design extensions can be designed using the male wedge cross feature. This can ensure all new bracket designs have the same reliable tilt, roll, and 90-degree orientation. Additionally, the modular wedge cross design can be used to integrate additional reference surfaces to alignment tool 110.

The wedge cross design also allows alignment tool 120 to be rotated at 90-degree intervals so it can be repositioned if the tool position is obstructed at the antenna site. Software is utilized, for example, in an associated smartphone app to compensate for the final position of the tool and report the actual alignment of the antenna.

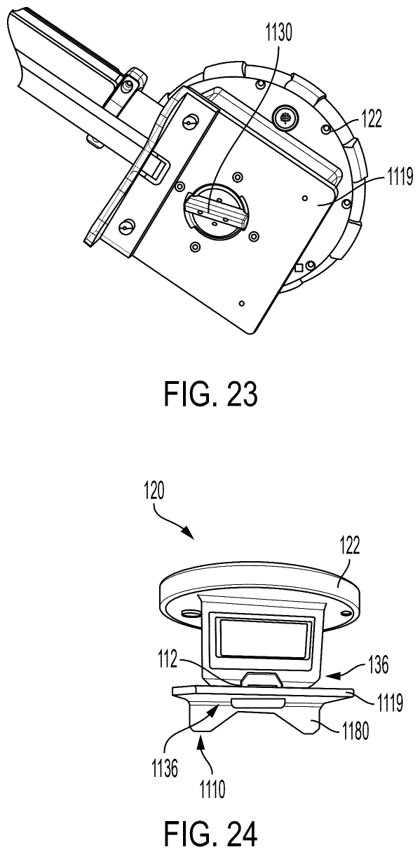

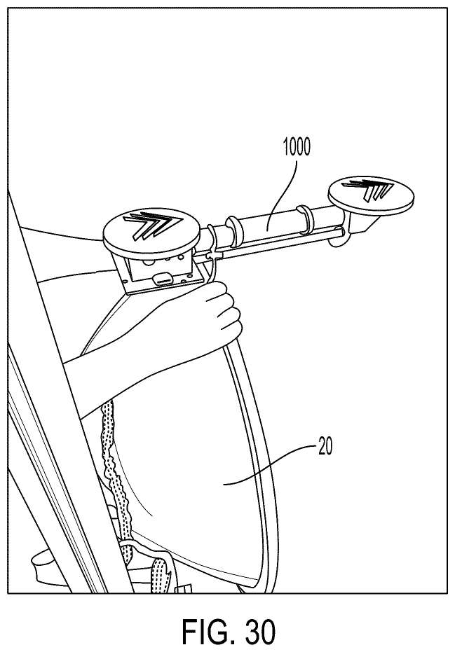

System 1000 is described with simultaneous reference to FIGS. 22 to 30. Antenna alignment system 1000 includes a bracket 1100 and an alignment tool 120 that can be secured together by a clamp 130. Bracket 110 provides an interface between alignment tool 120 and antenna 10.

Bracket 1110 includes a reference bar 1170 that, in operation, should be aligned with the azimuth and a reference surface 1118, which is perpendicular to reference bar 1170. Reference surface 1118 is disposed on an L bracket that connects to plate 1119.

In an antenna alignment system 1000, a second mating half 1134 located on bracket 1110 mates with first mating half 136 located on alignment tool 120 at attachment interface 1112.

Second mating half 134 is substantially identical to second mating half 1134 except that second mating half 1134 is not lever-activated. Instead, rotation is achieved by rotation of a knob 1130 located under plate 1119. Knob 1130 causes rotation of cog 144 to lock teeth 138 of alignment tool 120 in place.

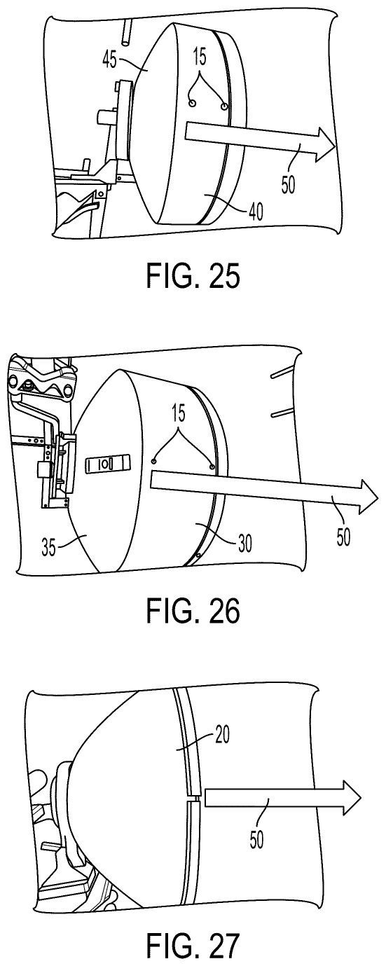

FIGS. 25 to 27 show example antennas for which antenna alignment system 1000 can be used. Each of these is a WISP-style dish and the type of parabolic dish commonly used by Wireless Internet Service Providers (WISPs) to deliver broadband internet services, especially in rural or remote areas where traditional wired infrastructure is lacking or impractical. These dish antennas are designed for point-to-point (PTP) or point-to-multipoint (PTMP) wireless communication, typically operating in unlicensed frequency bands such as 2.4 GHz or 5 GHz, or in licensed bands, depending on the regulatory environment. Precise alignment is essential for WISP-style dishes to function effectively. Antenna alignment tools are often used to adjust the azimuth and elevation angles accurately, optimizing the link quality between the service provider's base station and the customer's premises equipment.

Referring to FIGS. 25 to 27, azimuth 50 for each antenna is shown. In FIGS. 25 and 26, antennas 30 and 40 each have a pair of drainage holes. These can be used as an azimuth reference indicator 15 since a line connecting each hole is parallel to the azimuth. Similarly, in FIG. 27, antenna 20 has an indentation or other feature that is intended as an azimuth reference indicator 15′.

These indicators 15, 15′ can be aligned with reference bar 1170, and a rear surface 35 and 45 can be abutted against reference surface 1118 of bracket 1110 to provide alignment.

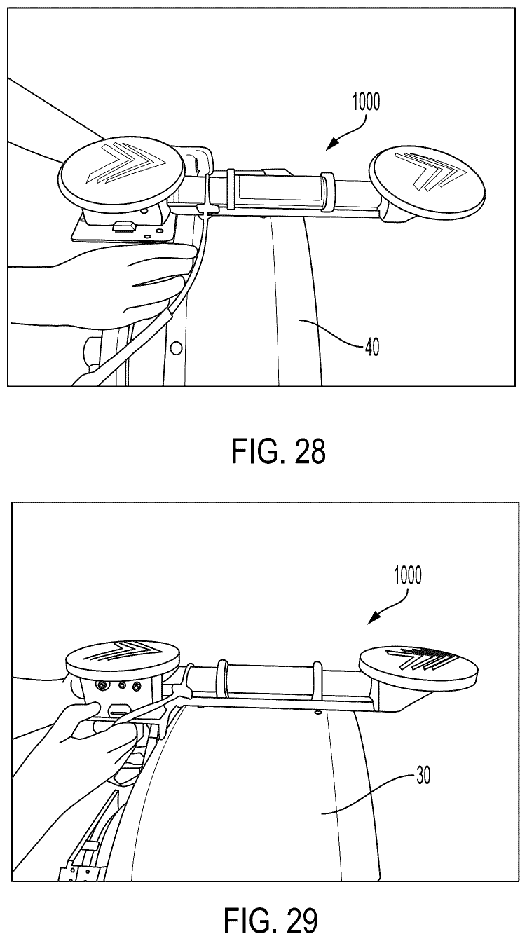

A method is also provided. The method includes mounting alignment tool 120 on bracket 1110, aligning reference bar 1170 with indicator 15, 15′, and reference surface 1118 with a front or rear surface of the antenna. This method allows a simple procedure to provide alignment of alignment tool 120 and the azimuth. The method further includes using the alignment tool to adjust the antenna alignment. An example for each of antennas 20, 30, and 40 is shown in FIGS. 28 to 30. Advantageously, this enables a manual hand mounting on an antenna to find alignment.

It should also be noted that the terms “first”, “second”, “third”, “upper”, “lower”, and the like may be used herein to modify various elements. These modifiers do not imply a spatial, sequential, or hierarchical order to the modified elements unless specifically stated.

As used herein, the term “substantially” refers to the complete or nearly complete extent or degree of an action, characteristic, property, state, structure, item, or result. The exact allowable degree of deviation from absolute completeness can, in some cases, depend on the specific context. However, generally speaking, the nearness of completion will be to have the same overall result as if absolute and total completion were obtained.

As used herein, the term “about” is used to provide flexibility to a numerical range endpoint by providing that a given value may be “a little above” or “a little below” the endpoint. Further, where a numerical range is provided, the range is intended to include any and all numbers within the numerical range, including the endpoints of the range.

While the present disclosure has been described with reference to one or more examples, it will be understood by those skilled in the art that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular examples disclosed as the best mode contemplated, but that the disclosure will include all examples falling within the scope of the appended claims.

What is claimed is:

1. A system comprising:
an alignment tool having a first tool antenna and a second tool antenna;
a bracket;
a first clamp portion carried by one of the alignment tool and the bracket; and
a second clamp portion carried by the other of the alignment tool and the bracket,
wherein the first clamp portion and the second clamp portion are operatively mateable and removable from one another to releasably secure the alignment tool to the bracket, and
wherein the first clamp portion has at least two coupling regions that are spaced apart and simultaneously engageable with a respective at least two coupling regions of the second clamp portion.

2. The system of claim 1, wherein the alignment tool includes a proximal portion and a distal portion connected by a horizontally extending arm, and wherein the first tool antenna is in the proximal portion and the second tool antenna is in the distal portion.

3. The system of claim 1, wherein the alignment tool is mountable to the bracket in a plurality of discrete orientations relative to the bracket.

4. The system of claim 1, wherein the alignment tool is mountable to the bracket in four orientations spaced 90 degrees apart.

5. The system of claim 1, wherein the bracket includes a strap and ratcheting levers configured to tighten the strap around an antenna to be aligned.

6. The system of claim 1, wherein the bracket includes an orienting bar having a reference surface to register the bracket to an antenna to be aligned.

7. The system of claim 1, wherein the bracket carries identical instances of one of the first clamp portion and the second clamp portion on opposite sides of the bracket, and the alignment tool carries the other one of the first clamp portion and the second clamp portion.

8. The system of claim 1, wherein the bracket further includes a reference bar and a perpendicular reference surface configured to align with an azimuth indicator of a dish antenna to be aligned.

9. The system of claim 1, wherein the first clamp portion and the second clamp portion are rotatably lockable between a locked position in which the first clamp portion and the second clamp portion secure the alignment tool to the bracket and an unlocked position in which the first clamp portion and the second clamp portion are separable.

10. The system of claim 9, wherein one of the first clamp portion and the second clamp portion comprises a male wedge-cross feature and the other comprises a complementary female wedge-cross feature configured to receive the male wedge-cross feature, wherein rotation from the unlocked position to the locked position drives the male wedge-cross feature and the complementary female wedge-cross feature into a wedged interface.

11. The system of claim 9, further comprising an actuator lever operably coupled to one of the first clamp portion and the second clamp portion, the actuator lever being configured to rotate the first clamp portion and the second clamp portion between the unlocked position and the locked position.

12. The system of claim 9, wherein one of the first clamp portion and the second clamp portion includes a ramp configured to engage an undercut feature of the other to draw the first clamp portion and the second clamp portion together during rotation into the locked position.

13. The system of claim 9, wherein one of the first clamp portion and the second clamp portion includes a ramp that is retracted in the unlocked position and that, during rotation into the locked position, advances to engage an undercut feature of the other to draw the first clamp portion and the second clamp portion together.

14. The system of claim 9, wherein one of the first clamp portion and the second clamp portion includes a plurality of teeth, and wherein the other of the first clamp portion and the second clamp portion includes a rotatable element having protrusions configured to capture the teeth in the locked position.

15. The system of claim 9, wherein cooperating tapered mating surfaces of the first clamp portion and the second clamp portion are configured, upon rotation into the locked position, to form a zero-clearance interface.

16. The system of claim 9, wherein one of the first clamp portion and the second clamp portion includes a cog rotatable about a hub, wherein rotation of the cog from the unlocked position to the locked position positions a protrusion of the cog to capture a tooth of the other of the first clamp portion and the second clamp portion.

17. A method, the method comprising:
mating a first clamp portion carried by one of an alignment tool and a bracket with a second clamp portion carried by the other by rotating the first clamp portion and the second clamp portion from an unlocked position to a locked position to secure the alignment tool to the bracket.

18. The method of claim 17, further comprising moving the first clamp portion and the second clamp portion to the unlocked position to release the alignment tool.

19. The method of claim 17, further comprising:
aligning a reference bar of the bracket with an azimuth indicator of an antenna to be aligned and abutting a reference surface of the bracket against a surface of the antenna to be aligned.

20. An antenna alignment tool comprising:
a first tool antenna;
a second tool antenna; and
a first clamp portion carried by the tool, the first clamp portion being configured to operatively mate with and be removable from a complementary second clamp portion on a bracket to releasably secure the antenna alignment tool to the bracket.
